(19) United States
(12) Patent Application Publication
(10) Pub. No.: US 2022/0090921 A1
(43) Pub. Date: Mar. 24, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Noriaki Saitoh, Nagoya-shi Aichi-ken (JP); Tamaki Amano, Shinjuku-ku Tokyo-to (JP); Yutaka Nakano, Setagaya-ku Tokyo-to (JP); Kota Arai, Kita-ku Tokyo-to (JP)

(21) Appl. No.: 17/478,004

(22) Filed: Sep. 17, 2021

(30) Foreign Application Priority Data
Sep. 18, 2020 (JP) 2020-157598

(51) Int. Cl. G01C 21/34; G01C 21/36

(52) U.S. Cl. CPC G01C 21/343; G01C 21/3614

(57) ABSTRACT

An object of the present disclosure is to acquire information that can be used for trade area analysis. An information processing apparatus includes a storage and a controller. The storage stores travel information about a plurality of vehicles, the travel information including position information on a starting point and an end point of one trip. The controller extracts, from the storage, the travel information about a plurality of target vehicles with respect to which the end point of one trip is a predetermined target place. Furthermore, the controller specifies a starting point range that is a range where the starting point of one trip of each of the plurality of target vehicles is present.

### CROSS REFERENCE TO THE RELATED APPLICATION

This application claims the benefit of Japanese Patent Application No. 2020-157598, filed on Sep. 18, 2020, which is hereby incorporated by reference herein in its entirety.

### BACKGROUND

### Technical Field

The present disclosure relates to information processing that is used for trade area analysis.

### Description of the Related Art

Patent Literature 1 discloses a technology related to trade area analysis that uses route search results accumulated in a database. In Patent Literature 1, a server apparatus includes route storage means that stores route search results associated with respective points including a destination or a route point. The server apparatus receives an analysis request including point information input by a user, from a browser terminal apparatus. Furthermore, the server apparatus extracts from the route storage means a route search result indicating that a point (a destination or a route point) included in the point information is reached.

[Patent Literature 1] Japanese Patent Laid-Open

### SUMMARY

The present disclosure is aimed at acquiring information that can be used for trade area analysis.

A first aspect of the present disclosure is an information processing apparatus comprising a storage and a controller, wherein

the storage stores travel information about a plurality of vehicles, the travel information including position information on a starting point and an end point of one trip, and

the controller is configured to

extract, from the storage, the travel information about a plurality of target vehicles with respect to which the end point of one trip is a predetermined target place, and

specify, based on the travel information about the plurality of target vehicles, a starting point range that is a range where the starting point of one trip of each of the plurality of target vehicles is present.

According to the present disclosure, information that can be used for trade area analysis may be acquired.

### BRIEF DESCRIPTION OF THE DRAWINGS

FIG. 1 is a diagram for describing a trade area analysis according to an embodiment;

FIG. 2 is a diagram illustrating a schematic configuration of an information management system according to the embodiment;

FIG. 3 is a block diagram schematically illustrating an example of a functional configuration of a management server;

FIG. 4 is a diagram illustrating an example of a table structure of travel information;

FIG. 5 is a flowchart illustrating a flow of information processing, according to a first embodiment, that is performed by a controller;

FIG. 6 is a diagram illustrating an example of a place as a target place, that is selected by a user on a map displayed on a display;

FIG. 7 is a diagram illustrating an example of a starting point range according to the first embodiment, that is on a map displayed on the display;

FIG. 8 is a flowchart illustrating a flow of information processing, according to a second embodiment, that is performed by the controller;

FIG. 9 is a diagram illustrating an example of a starting point range according to the second embodiment, that is on a map displayed on the display; and

FIG. 10 is a diagram illustrating an example of a starting point range according to a third embodiment, that is on a map displayed on the display.

### DESCRIPTION OF THE EMBODIMENTS

An information processing apparatus according to a first mode of the present disclosure includes a storage and a controller. The storage stores travel information about a plurality of vehicles. The travel information includes position information about a starting point and an end point of one trip of each vehicle. The controller may extract, from the storage, the travel information about a plurality of target vehicles. The target vehicle here is a vehicle with respect to which an end point of one trip included in the travel information is a predetermined target place. The predetermined target place is a place that is a target of trade area analysis (such as a commercial facility). The predetermined target place may be freely set.

Furthermore, the controller may specify a starting point range based on the travel information about the plurality of target vehicles extracted from the storage. The starting point range is a range where the starting point of one trip of each of the plurality of target vehicles is present. The starting point of one trip exists for each target vehicle that moved to the predetermined target place in one trip. A geographical range including respective starting points of the plurality of target vehicles is specified as the starting point range.

Here, in the case where a vehicle moves to a predetermined target place in one trip, the predetermined target place is highly likely to be a destination of an occupant of the vehicle. That is, the occupant of the vehicle that moved to the predetermined target place in one trip is highly likely to be a visitor who moved to the predetermined target place as the destination. Accordingly, a starting point range for a plurality of target vehicles may be taken to be a range where visitors who visit the predetermined target place are present. Accordingly, a trade area for the predetermined target place may be grasped by specifying the starting point range for the plurality of target vehicles.

In the following, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

(Trade Area Analysis)

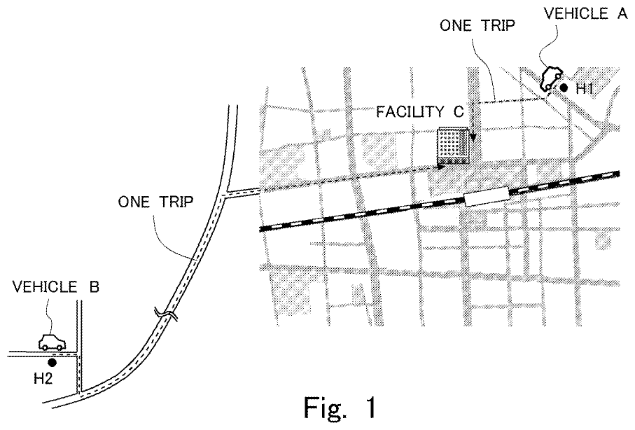

FIG. 1 is a diagram for describing trade area analysis according to a present embodiment. A description will be given by citing, as an example, a case where a facility C on a map illustrated in FIG. 1 is the target of trade area analysis.

Visitors visit the facility C from various places. In many cases, a visitor who visits the facility C by a vehicle moves to the facility C in one trip, with home or the like as a starting point. For example, in FIG. 1, a visitor a visits the facility C by a vehicle A, from a home H1 that is relatively close to the facility C. Furthermore, another visitor b visits the facility C by a vehicle B, from a home H2 that is relatively far from the facility C. In this manner, in many cases, even when distances from the facility C to the homes H1, H2 are different, the vehicles A, B both move to the facility C in one trip. At this time, in relation to one trip of the vehicle A, the home H1 is the starting point and the facility C is the end point. Furthermore, in relation to the vehicle B, the home H2 is the starting point and the facility C is the end point. In other words, in the case where a vehicle moves to the facility C in one trip, the facility C is highly likely to be the destination of an occupant on board the vehicle, regardless of a movement distance to the facility C. Accordingly, a geographical range where the starting point of one trip of each vehicle that moved to the facility C in one trip is present may be taken to be a range where visitors whose destinations are the facility C are present. Accordingly, in the present embodiment, the place as the target of trade area analysis is taken to be the target place. Moreover, as processing for trade area analysis, a process of specifying, as the starting point range, a geographical range including the starting point of one trip of each vehicle that moved to the predetermined target place in one trip is performed.

(System Configuration)

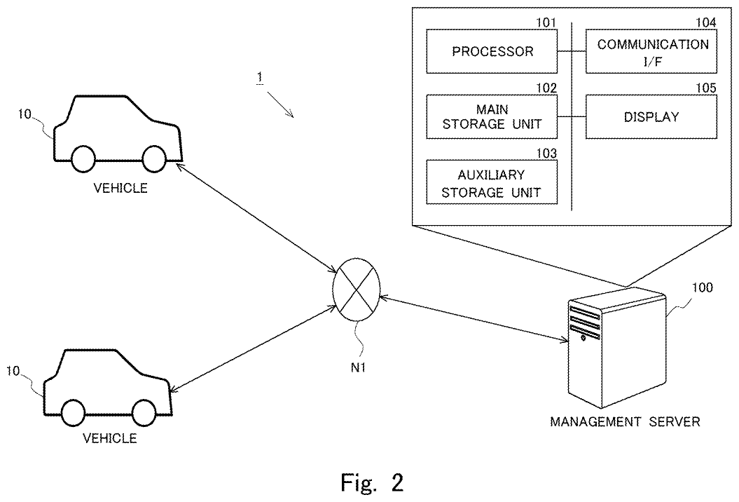

FIG. 2 is a diagram illustrating a schematic configuration of an information management system according to the present embodiment. In the information management system, a management server 100 receives travel information from a plurality of vehicles 10 over a network N1. As the network N1, a wide area network (WAN), which is a worldwide public communication network such as the Internet, or a mobile communication network for mobile phones may be adopted, for example.

The travel information that is transmitted from each vehicle 10 includes position information on the starting point and the end point of one trip of the vehicle 10. Here, the starting point of one trip is a position where a start switch of the vehicle 10 is switched on. Furthermore, the end point of one trip is a position where the start switch of the vehicle 10 is switched off. For example, in the case where the vehicle 10 is an engine vehicle that uses an engine as a driving source, a position where an ignition switch is switched on is the starting point of one trip, and a position where the ignition switch is switched off is the end point of one trip. Furthermore, for example, the starting point of one trip may be a position where an ACC of the vehicle 10 is switched on, and the end point of one trip may be a position where the ACC of the vehicle 10 is switched off.

Furthermore, the travel information includes information about dates/times of one trip. Here, the dates/times of one trip are a date/time when the start switch of the vehicle 10 is switched on at the starting point of one trip, and a date/time when the start switch of the vehicle 10 is switched off at the end point of one trip. Moreover, the travel information includes information about a required time of one trip. Specifically, the required time of one trip included in the travel information is a period of time from when the start switch of the vehicle 10 is switched on at the starting point of one trip to when the start switch of the vehicle 10 is switched off at the end point of one trip. Each vehicle 10 may transmit the travel information to the management server 100 every time one trip ends (that is, every time the start switch is switched off).

The management server 100 includes a regular computer. The computer of the management server 100 includes a processor 101, a main storage unit 102, an auxiliary storage unit 103, a communication interface (a communication I/F) 104, and a display 105.

The processor 101 is a central processing unit (CPU) or a digital signal processor (DSP), for example. The main storage unit 102 is a random access memory (RAM), for example. The auxiliary storage unit 103 is a read only memory (ROM), a hard disk drive (HDD), or a flash memory, for example. The auxiliary storage unit 103 may also include a removable medium (a removable recording medium). The removable medium here is a USB memory, an SD card, or a disk recording medium such as a CD-ROM, a DVD disc, or a Blu-ray disc, for example. The communication I/F 104 is a local area network (LAN) interface board, or a wireless communication circuit for wireless communication, for example. The display 105 is a display that can be operated by a user performing trade area analysis. The display 105 is a touch panel display, for example.

The auxiliary storage unit 103 stores an operating system (OS), various programs, various information tables, and the like. A process as described below for specifying the starting point range for a predetermined target place is performed by the processor 101 loading programs stored in the auxiliary storage unit 103 into the main storage unit 102 and executing the same. However, functions of the management server 100 may be partially or entirely implemented by a hardware circuit such as an ASIC or an FPGA. Additionally, the management server 100 does not necessarily have to be a single physical structure, and may include a plurality of computers that operate in conjunction with each other. For example, a computer including the processor 101, the main storage unit 102, the auxiliary storage unit 103, and the communication I/F 104 and a computer including the display 105 to be operated by a user may be different structures that are capable of communicating with each other.

(Functional Configuration)

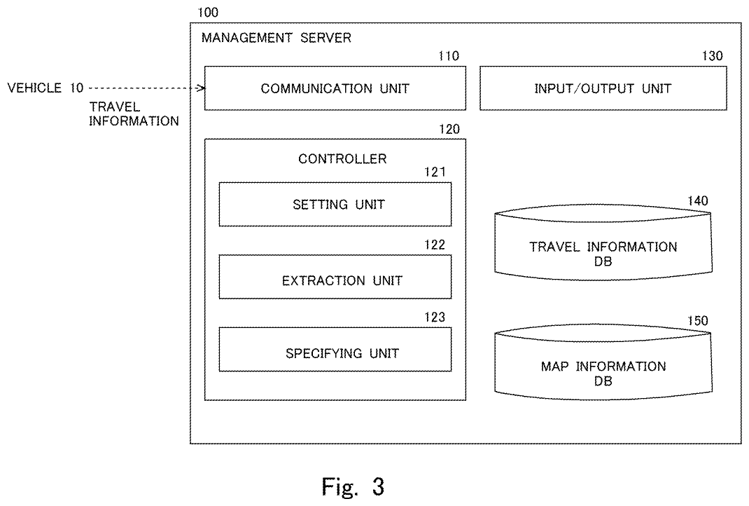

A functional configuration of the management server 100 will be described with reference to FIG. 3. FIG. 3 is a block diagram schematically illustrating an example of the functional configuration of the management server 100. Additionally, in the present embodiment, the management server 100 corresponds to “information processing apparatus” according to the first mode of the present disclosure.

The management server 100 includes a communication unit 110, a controller 120, an input/output unit 130, a travel information database (a travel information DB) 140, and a map information database (a map information DB) 150. The communication unit 110 includes a function of connecting the management server 100 to the network N1. The communication unit 110 may be implemented by the communication I/F 104.

The controller 120 includes a function of performing arithmetic processing for controlling the management server 100. The controller 120 may be implemented by the processor 101. Furthermore, the controller 120 performs a process of receiving the travel information transmitted from each vehicle 10, by using the communication unit 110. Moreover, the controller 120 performs a process of storing the travel information received from each vehicle 10 in the travel information DB 140.

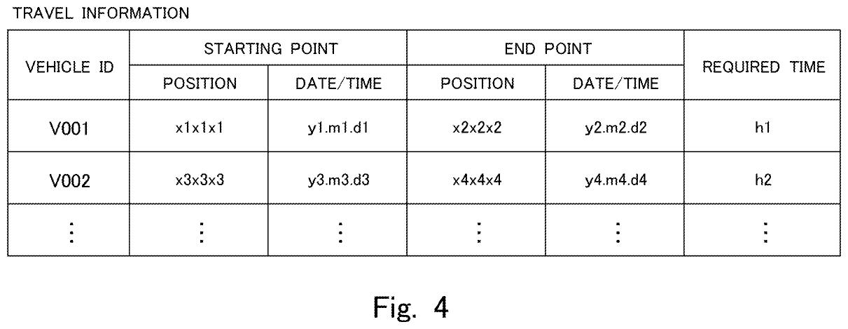

FIG. 4 is a diagram illustrating an example of a table structure of the travel information stored in the travel information DB 140. As described above, the travel information transmitted from each vehicle 10 includes the position information on the starting point and the end point of one trip of the vehicle 10, information about the dates/times of one trip, and the required time of one trip. Such travel information is stored in the travel information DB 140, in association with a vehicle ID of the vehicle 10 that is the transmission source. The vehicle ID is identification information for specifying the vehicle 10.

As illustrated in FIG. 4, the travel information that is stored in the travel information DB 140 includes a vehicle ID field, a starting point field, an end point field, and a required time field. The vehicle ID of the vehicle 10 that is the transmission source of the travel information is input in the vehicle ID field. The position of the starting point of one trip, and the date/time when the start switch of the vehicle 10 is switched on at the starting point of one trip are input in the starting point field. The position of the end point of one trip and the date/time when the start switch of the vehicle 10 is switched off at the end point of one trip are input in the end point field. The required time of one trip is input in the required time field. Additionally, in the case where travel information for a plurality of trips is received from one vehicle 10 by the management server 100, the travel information for each trip is stored in the travel information DB 140. The travel information DB 140 is structured in the auxiliary storage unit 103 by execution of a program of a database management system by the processor 101.

Furthermore, the controller 120 includes a setting unit 121, an extraction unit 122, and a specifying unit 123. Functions of these functional units will be described later in detail. The input/output unit 130 includes the display 105. The input/output unit 130 includes a function of displaying a map that is stored in the map information DB 150 on the display 105. Moreover, the input/output unit 130 includes a function of receiving an operation that is performed by a user on the display 105. A user is thus enabled to freely select a target place to be the target of trade area analysis, on a map that is displayed on the display 105.

Furthermore, the setting unit 121 of the controller 120 sets, as the target place, a place that is selected by a user on the map displayed on the display 105. Furthermore, the extraction unit 122 of the controller 120 extracts the travel information about a plurality of target vehicles from the travel information DB 140. A target vehicle here is a vehicle with respect to which the target place set by the setting unit 121 is the end point of one trip. That is, the extraction unit 122 extracts, from the travel information DB 140, as the travel information about a target vehicle, the travel information about a vehicle with respect to which the position of the end point of one trip input in the end point field is the position of the target place. Furthermore, the specifying unit 123 of the controller 120 specifies, as the starting point range, a range including the starting point of one trip of each of the plurality of target vehicles. That is, the specifying unit 123 specifies, as the starting point range, a geographical range that includes the starting point of one trip in the travel information about each of the plurality of target vehicle that is extracted by the extraction unit 122.

(Information Processing)

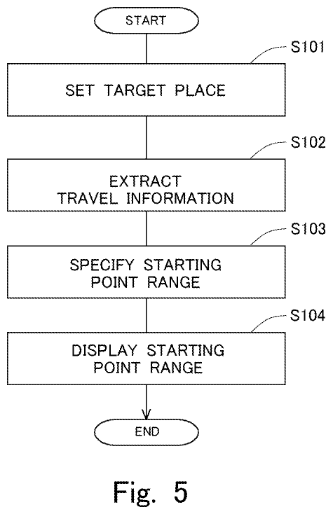

Next, information processing that is performed by the controller 120 of the management server 100 to output the starting point range for the target place that is selected by the user will be described with reference to FIG. 5. FIG. 5 is a flowchart illustrating a flow of information processing, according to the present embodiment, that is performed by the controller 120.

In the present flow, first, a target place is set in S101. The process in S101 is performed by the setting unit 121.

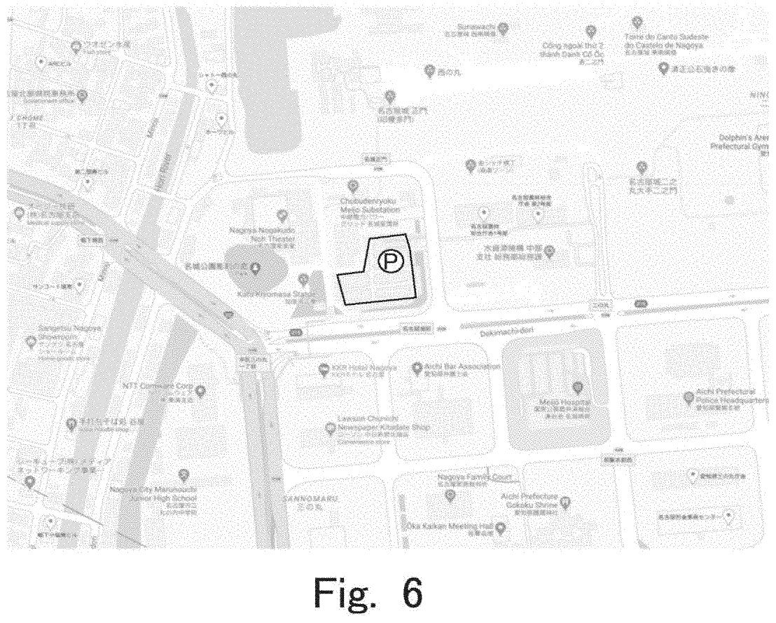

Here, a place that is selected by being freely encircled by the user on the map displayed on the display 105 may be set as the target place, for example. FIG. 6 is a diagram illustrating an example of a place as the target place, that is selected by the user on the map displayed on the display 105. In FIG. 6, a parking lot P encircled by a solid line is selected. Accordingly, the setting unit 121 sets the parking lot P as the target place. Therefore, a vehicle for which a position that is close to the parking lot P but is shifted from the parking lot P is the end point of one trip may be excluded from target vehicles. That is, because the user is enabled to freely encircle and select a target place on the map displayed on the display 105, the user is able to exclude, from target vehicles, a vehicle that moved to a destination that is a place shifted from a place that is desired by the user to be the target of trade area analysis.

Next, in S102, the travel information about a plurality of target vehicles is extracted from the travel information DB 140, based on the target place set in S101. The process in S102 is performed by the extraction unit 122.

Now, during movement, a visitor moving by a vehicle toward the target place sometimes stops by a place other than the target place for rest or the like. At this time, the visitor possibly temporarily switches off the start switch of the vehicle at the place where the visitor stopped by. However, in such a case, the start switch of the vehicle is likely to be switched on again after a relatively short period of time. In such a case, the travel information for a plurality of trips is stored in the travel information DB 140 for the same vehicle. Furthermore, in relation to the travel information for two trips of the same vehicle, a length of a period of time from when the start switch is temporarily switch off to when the start switch is switched on again is equal to or less than a predetermined OFF period. The predetermined OFF period here may be a threshold for determining that a visitor moving by a vehicle toward a target place stopped the vehicle to, for example, rest during movement. At this time, the extraction unit 122 does not have to take the position where the start switch is switched off as the end point of one trip. For example, the travel information DB 140 possibly stores the travel information for first one trip the position of whose end point is the target place, and the travel information for second one trip the position of whose end point is the position of the starting point of the first one trip. Furthermore, a length of a period of time from a date/time when the start switch is switched off at the end point of the second one trip to a date/time when the start switch is switched on at the starting point of the first one trip is possibly equal to or less than the predetermined OFF period. In such a case, the travel information about the first one trip and the travel information about the second one trip are treated as the travel information for one trip. Accordingly, the travel information for one trip for which the starting point is the starting point of the second one trip and the end point is the end point of the first one trip is extracted as the travel information about the target vehicle.

Next, in S103, the starting point range is specified based on the travel information about the plurality of target vehicles extracted in 5102. The process in 5103 is performed by the specifying unit 123. Then, in 5104, the starting point range specified in 5103 is displayed, via the input/output unit 130, on the map displayed on the display 105.

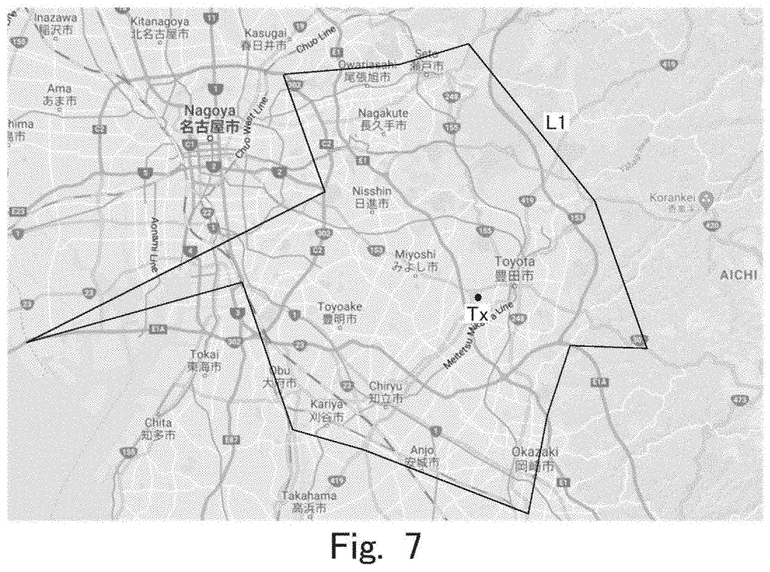

FIG. 7 is a diagram illustrating an example of the starting point range on the map displayed on the display 105. In FIG. 7, the starting point range for a target place Tx is indicated by a solid line L1. As described above, movement distances of vehicles that move to a target place as the destination are varied. Accordingly, as illustrated in FIG. 7, the starting points of one trips of a plurality of target vehicles are not necessarily distributed in a range with equal distances from the target place. Accordingly, by specifying a range where visitors who visit a target place by vehicles are present as the starting point range, the trade area for the target place may be more appropriately grasped.

Additionally, the user may select, as the target place, a plurality of places on the map displayed on the display 105 of the management server 100. In this case, the controller 120 sets each of the plurality of places selected by the user, as the target place. Then, the controller 120 specifies the starting point range for each target place, and displays the same on the map displayed on the display 105.

### Second Embodiment

The functional configuration of the management server 100 according to a present embodiment is the same as the functional configuration according to the first embodiment. In the present embodiment, in the information processing for outputting the starting point range for a target place that is selected by a user, the travel information about a plurality of target vehicles is extracted from the travel information DB 140 based on a predetermined extraction condition.

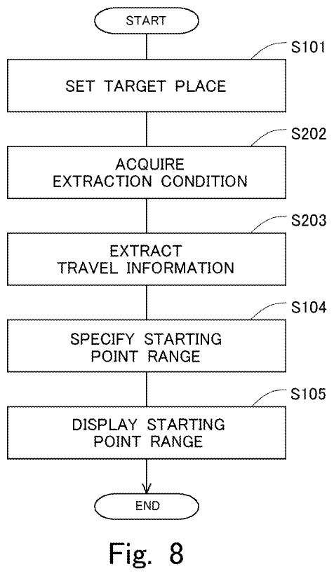

FIG. 8 is a flowchart illustrating a flow of information processing, according to the present embodiment, that is performed by the controller 120. The process that is performed in each step of S101, S104 and S105 in the present flow is the same as the process that is performed in the step with the same reference numeral in the flow illustrated in FIG. 6. Accordingly, description of the processes performed in these steps will be omitted.

In the present flow, in S202, a predetermined extraction condition regarding extraction of the travel information about a plurality of target vehicles from the travel information DB 140 is acquired. As the extraction condition, Condition 1 or Condition 2 as follows may be cited as an example.

(Condition 1) The required time for one trip is equal to or less than a predetermined period of time.

(Condition 2) The date/time of one trip is a predetermined date/time.

Additionally, the predetermined period of time in Condition 1 may be freely set. Furthermore, a plurality of periods of time may be set as the predetermined period of time. The predetermined date/time in Condition 2 may be freely set. Furthermore, a day of a week may be set as the predetermined date/time. Moreover, both Condition 1 and Condition 2 may be included in the predetermined extraction condition.

Then, in S203, the travel information about a plurality of target vehicles is acquired from the travel information DB 140 based on the target place set in S101 and the predetermined extraction condition acquired in S202. For example, in the case where the predetermined extraction condition is Condition 1 described above, the travel information about a plurality of target vehicles with respect to each of which the end point of one trip is the target place and the required time of one trip is equal to or less than the predetermined period of time is extracted from the travel information DB 140. Furthermore, in the case where the predetermined extraction condition is Condition 2 described above, the travel information about a plurality of target vehicles with respect to each of which the end point of one trip is the target place and the date/time of one trip is the predetermined date/time is extracted from the travel information DB 140. Next, the starting point range is specified in 5104 based on the travel information about the plurality of target vehicles extracted in S203.

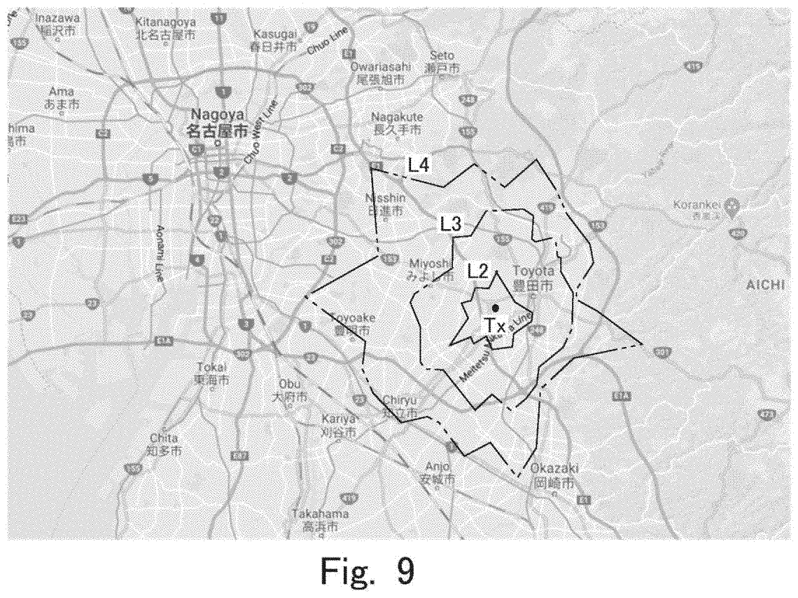

FIG. 9 is a diagram illustrating an example of the starting point range on the map displayed on the display 105, where the predetermined extraction condition is Condition 1 described above. In FIG. 9, the starting point ranges for the target place Tx are indicated by a solid line L2, a dash-dotted line L3, and a dash-dot-dotted line L4. The solid line L2, the dash-dotted line L3, and the dash-dot-dotted line L4 here indicate the starting point ranges for which the predetermined periods of time in Condition 1 are different. That is, the plurality of predetermined periods of time corresponding to L2, L3, and L4 are set such that a relationship L2 <L3 <L4 is true. As illustrated in FIG. 9, in the case where the predetermined extraction condition is Condition 1, the starting point range may be grasped for each required time that is taken to move to the target place by a vehicle.

Moreover, in the case where the predetermined extraction condition is Condition 2 described above, the starting point range may be grasped for each date/time (such as each day of a week) of visit to the target place. In this manner, according to the present embodiment, the starting point range for a target place according to the predetermined extraction condition may be grasped.

### Third Embodiment

The functional configuration of the management server 100 according to a present embodiment is the same as the functional configuration according to the first embodiment. In the present embodiment, in the information processing for outputting the starting point range for a target place, a range where a predetermined proportion of starting points is present, in a range where the starting point of one trip of each of a plurality of target vehicles is present, is specified as the starting point range.

Also in the present embodiment, at the controller 120 of the management server 100, the extraction unit 122 extracts the travel information about a plurality of target vehicles from the travel information DB 140. Then, the specifying unit 123 specifies, as the starting point range, a geographical range including a predetermined proportion of starting points among all the starting points included in the travel information about the plurality of target vehicles extracted by the extraction unit 122. Additionally, the predetermined proportion may be freely set, and may be 70%, for example. Furthermore, at the time of selecting the starting point to be included in the starting point range from all the starting points, the specifying unit 123 may exclude, from options, a starting point in a region with a low concentration of starting points. Furthermore, also in the present embodiment, the controller 120 displays the specified starting point range on the map that is displayed on the display 105.

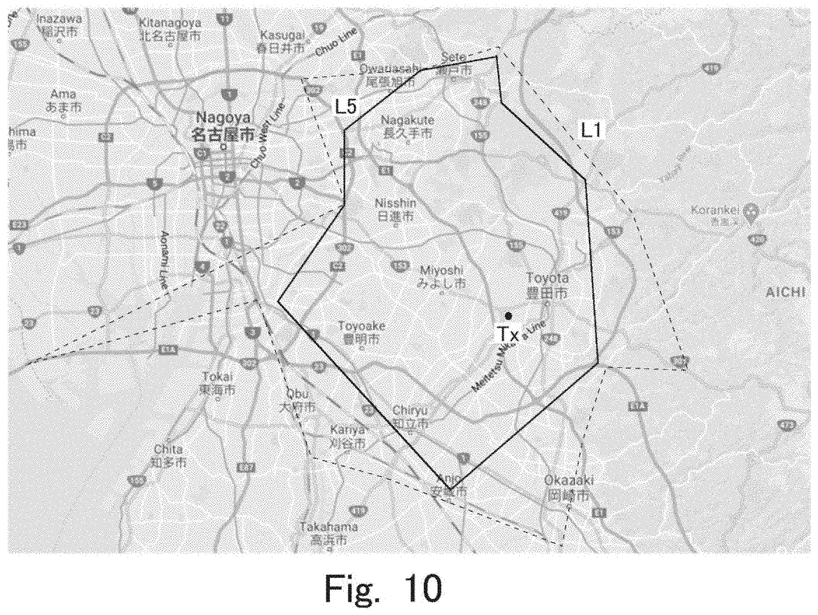

FIG. 10 is a diagram illustrating an example of the starting point range according to the present embodiment, that is on the map displayed on the display 105. In FIG. 10, the starting point range for the target place Tx is indicated by a solid line L5. Additionally, a broken line L1 in FIG. 10 indicates the starting point range for the target place Tx indicated in FIG. 7 by the solid line L1, or in other words, the range where all the starting points included in the travel information about a plurality of target vehicles extracted by the extraction unit 122 are present.

As illustrated in FIG. 10, according to the present embodiment, the starting point range for a target place is narrowed down to a range where a predetermined proportion of starting points is present, from a range where the starting point of one trip of every one of a plurality of target vehicles is present. A starting point that is irregular for a starting point of a vehicle that moves to the target place as the destination may thus be excluded from the starting point range. Accordingly, a range that may be highly probably taken to be the trade area for a target place may be grasped.

<Other Embodiments>

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a storage and a controller, wherein
the storage stores travel information about a plurality of vehicles, the travel information including position information on a starting point and an end point of one trip, and
the controller is configured to
extract, from the storage, the travel information about a plurality of target vehicles with respect to which the end point of one trip is a predetermined target place, and
specify, based on the travel information about the plurality of target vehicles, a starting point range that is a range where the starting point of one trip of each of the plurality of target vehicles is present.

2. The information processing apparatus according to claim 1, wherein
the travel information about the plurality of vehicles stored in the storage includes information about a required time of one trip, and
the controller extracts, from the storage, the travel information about the plurality of target vehicles with respect to which the end point of one trip is the predetermined target place and the required time is equal to or less than a predetermined period of time.

3. The information processing apparatus according to claim 1, wherein
the travel information about the plurality of vehicles stored in the storage includes information about a corresponding date and time of one trip, and
the controller extracts, from the storage, the travel information about the plurality of target vehicles with respect to which the end point of one trip is the predetermined target place and the corresponding date and time is a predetermined date and time.

4. The information processing apparatus according to claim 1, wherein the controller specifies, as the starting point range, a range where a predetermined proportion of starting points is present, in a range where the starting point of one trip of each of the plurality of target vehicles is present.

5. The information processing apparatus according to claim 1, wherein
the information processing apparatus further comprises a display that displays a map, and
the controller is further configured to set, as the predetermined target place, a place that is freely selected on the map that is displayed on the display.

6. The information processing apparatus according to claim 5, wherein the controller sets, as the predetermined target place, a place that is selected by being freely encircled on the map that is displayed on the display.

7. The information processing apparatus according to claim 5, wherein the controller is further configured to display the starting point range on the map that is displayed on the display.

8. The information processing apparatus according to claim 7, wherein, in a case where a plurality of places is set as the predetermined target place, the controller specifies, and displays on the map that is displayed on the display, the starting point range for each target place.

9. The information processing apparatus according to claim 1, wherein
the starting point of one trip included in the travel information about a vehicle is a position where a start switch of the vehicle is switched on, and
the end point of one trip included in the travel information about the vehicle is a position where the start switch of the vehicle is switched off.

10. The information processing apparatus according to claim 9, wherein, in a case where a length of a period of time from when the start switch is switched off to when the start switch is switched on again is equal to or less than that of a predetermined OFF period, the position where the start switch is switched off is not taken to be the end point of one trip.

11. An information processing method that is performed by a computer, the method comprising:
extracting, from a storage storing travel information about a plurality of vehicles that includes position information on a starting point and an end point of one trip, the travel information about a plurality of target vehicles with respect to which the end point of one trip is a predetermined target place; and
specifying, based on the travel information about the plurality of target vehicles, a starting point range that is a range where the starting point of one trip of each of the plurality of target vehicles is present.

12. The information processing method according to claim 11, wherein
the travel information about the plurality of vehicles stored in the storage includes information about a required time of one trip, and
the travel information about the plurality of target vehicles with respect to which the end point of one trip is the predetermined target place and the required time is equal to or less than a predetermined period of time is extracted from the storage.

13. The information processing method according to claim 11, wherein
the travel information about the plurality of vehicles stored in the storage includes information about a corresponding date and time of one trip, and
the travel information about the plurality of target vehicles with respect to which the end point of one trip is the predetermined target place and the corresponding date and time is a predetermined date and time is extracted from the storage.

14. The information processing method according to claim 11, wherein a range where a predetermined proportion of starting points is present, in a range where the starting point of one trip of each of the plurality of target vehicles is present, is specified as the starting point range.

15. The information processing method according to claim 11, further comprising setting, as the predetermined target place, a place that is freely selected on a map that is displayed on a display.

16. The information processing method according to claim 15, wherein a place that is selected by being freely encircled on the map that is displayed on the display is set as the predetermined target place.

17. The information processing method according to claim 15, further comprising displaying the starting point range on the map that is displayed on the display.

18. The information processing method according to claim 17, wherein, in a case where a plurality of places are set as the predetermined target place, the starting point range for each target place is specified and displayed on the map that is displayed on the display.

19. A non-transitory storage medium storing a program for causing a computer to perform an information processing method, wherein the information processing method includes
extracting, from a storage storing travel information about a plurality of vehicles that includes position information on a starting point and an end point of one trip, the travel information about a plurality of target vehicles with respect to which the end point of one trip is a predetermined target place, and
specifying, based on the travel information about the plurality of target vehicles, a starting point range that is a range where the starting point of one trip of each of the plurality of target vehicles is present.

20. The non-transitory storage medium according to claim 19, wherein
the travel information about the plurality of vehicles stored in the storage includes information about a required time of one trip, and
in the information processing method, the travel information about the plurality of target vehicles with respect to which the end point of one trip is the predetermined target place and the required time is equal to or less than a predetermined period of time is extracted from the storage.
